(19) United States
(12) Patent Application Publication
(10) Pub. No.: US 2016/0321758 A1
(43) Pub. Date: Nov. 3, 2016

(54) COMPUTING DEVICE, NON- TRANSITORY STORAGE MEDIUM, AND METHOD FOR CALCULATING VEHICLE INSURANCE FEE

(71) Applicants: Fu Tai Hua Industry (Shenzhen) Co., Ltd., Shenzhen (CN); HON HAI PRECISION INDUSTRY CO., LTD., New Taipei (TW)

(72) Inventors: QIONG-KE LI, Shenzhen (CN); JUAN XU, Shenzhen (CN); CHIH-SAN CHIANG, New Taipei (TW); YUN ZHAO, Shenzhen (CN); XIAO-LU QIN, Shenzhen (CN); JIA-ZUO CHEN, Shenzhen (CN)

(21) Appl. No.: 14/824,836

(22) Filed: Aug. 12, 2015

(30) Foreign Application Priority Data
Apr. 30, 2015 (CN) 201510214845.5

(51) Int. Cl. G06Q 40/08

(52) U.S. Cl. CPC G06Q 40/08

(57) ABSTRACT

In a method for calculating vehicle insurance fee, core data transmitted from an electronic device in a vehicle is received. The core date includes information as to how the vehicle is driven, by recording the driving style of the driver e, purchase price of the vehicle, and other basic information. A driving risk level of the vehicle is determined according to the received core data. A comprehensive risk coefficient associated with the driving risk level is obtained. An insurance fee of the vehicle is calculated based on the comprehensive risk coefficient and a preset sheet of parameters.

### CROSS-REFERENCE TO RELATED APPLICATIONS

This application claims priority to Chinese Patent Application No. 201510214845.5 filed on Apr. 30, 2015, the contents of which are incorporated by reference herein.

### FIELD

The subject matter herein generally relates to vehicle insurance, and more specifically relates to a computing device and a method for calculating vehicle insurance fee.

### BACKGROUND

A car owner purchases insurance for his or her car. Insurance products are priced according to various factors. For example, vehicle insurance may be priced according to an underwriting classification that may account for factors such as a driver's age, gender, location, driving record, and type of vehicle to be insured.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of one embodiment of function modules of a calculation system of vehicle insurance fee.

FIG. 2 is a flowchart of one embodiment of a method for obtaining data for calculating vehicle insurance fee.

FIG. 3 is a flowchart of one embodiment of a method for calculating vehicle insurance fee.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one.”

Furthermore, the word “module,” as used hereinafter, refers to logic embodied in hardware or firmware, or to a collection of software instructions, written in a programming language, such as, for example, Java, C, or assembly. One or more software instructions in the modules may be embedded in firmware. It will be appreciated that modules may comprise connected logic units, such as gates and flip-flops, and may comprise programmable units, such as programmable gate arrays or processors. The modules described herein may be implemented as either software and/or hardware modules and may be stored in any type of non-transitory computer-readable storage medium or other computer storage device. The term “comprising,” when utilized, means “including, but not necessarily limited to”; it specifically indicates open-ended inclusion or membership in the so-described combination, group, series and the like.

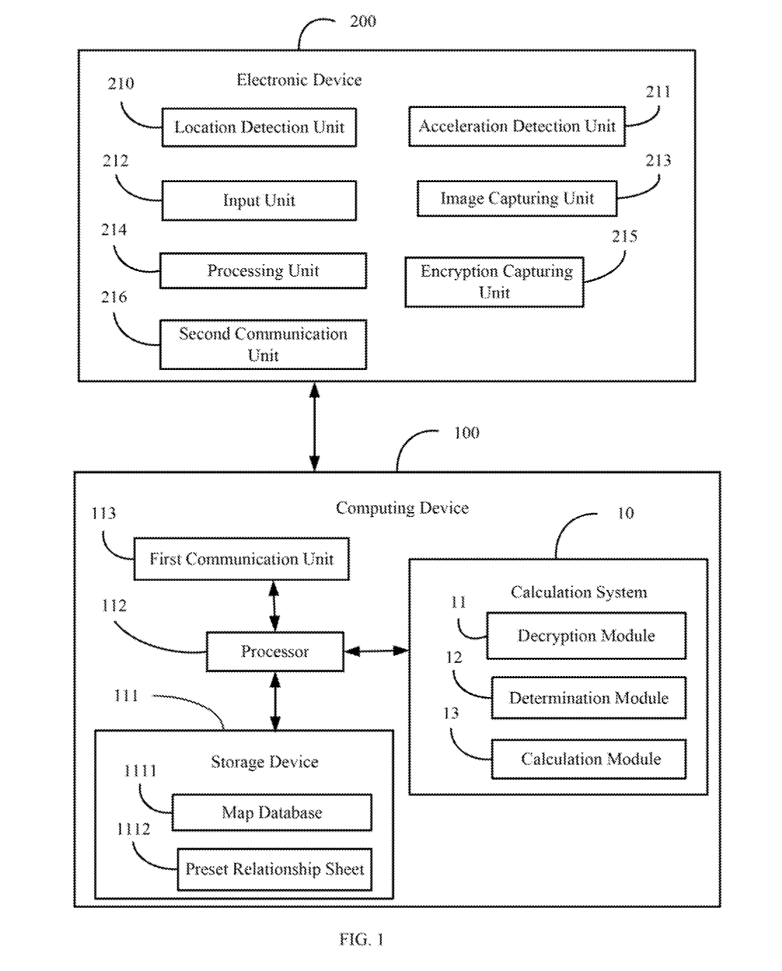

FIG. 1 is a block diagram of one embodiment of a calculation system of vehicle insurance fee (hereinafter “calculation system”). The calculation system 10 is installed and runs in an apparatus, for example a computing device 100. In at least one embodiment as shown in FIG. 1, the computing device 100 can communicate with an electronic device 200. The electronic device 200 is associated with a vehicle. In one embodiment, the electronic device 200 can be installed on a vehicle or on a component of the vehicle. The electronic device 200 further can be a portable electronic device carried by the driver of the vehicle, for example, a smart phone, or a tablet computer. In one embodiment, the vehicle is a car.

The electronic device 200 includes, but is not limited to, a location detection unit 210, an acceleration detection unit 211, an input unit 212, an image capturing unit 213, a processing unit 214, an encryption unit 215, and a second communication unit 216. The processing unit 12 can be a central processing unit (CPU), a microprocessor, or other data processor chip that performs functions of the electronic device 200.

The location detection unit 210 can detect locations of the electronic device 200 in the vehicle. In one embodiment, the location detection unit 210 can be a global positioning system (GPS) unit. The acceleration detection unit 211 can detect accelerations of the vehicle through the electronic device 200.

The locations and accelerations of the electronic device 200 equate to those of the vehicle when driven as the electronic device 200 is carried with or in the vehicle.

The input unit 212 can get basic information of the vehicle in response to input operations of a driver. In one embodiment, the basic information includes, but is not limited to, purchase price of the vehicle. In another embodiment, the basic information can be obtained from a vehicle website or directly from the vehicle manufacturer when the electronic device 200 communicates with the vehicle and the vehicle website, or the vehicle and a website of the vehicle manufacturing enterprise. The image capturing unit 213 can capture images of the driver when driving the vehicle. The processing unit 214 can process the images captured by the image capturing unit 213 and obtain driving style of the driver from the captured images. For example, the processing unit 214 compares the captured images with a number of pre-stored images to obtain driving style. The pre-stored images are associated with a dangerous or reckless driving style.

The processing unit 214 can further process the locations, accelerations of the vehicle, and driving style of the driver, and get a core data of the vehicle. In one embodiment, the core date includes driving data of the vehicle, driving style of the driver and basic information of the vehicle. The driving data of the vehicle includes locations where the vehicle is driven and accelerations which are greater than a preset acceleration. The driver's driving style, such as sudden braking or accelerating, which makes the acceleration rate greater than a preset acceleration, is considered reckless or dangerous. The basic information of the vehicle is the purchase price of the vehicle.

This system for providing vehicle insurance does not serve to calculate an initial insurance fee of a new vehicle which has no history in the driving data.

The encryption unit 215 can encrypt the core data obtained by the processing unit 214 according to a preset encryption algorithm. The second communication unit 216 can transmit the encrypted data to the computing device 100.

In at least one embodiment as shown in FIG. 1, the computing device 100 includes, but is not limited to, a storage device 111, at least one processor 112, and a first communication device 113. FIG. 1 illustrates only one example of the computing device; others can include more or fewer components than illustrated, or have a different configuration of the various components in other embodiments. In at least one embodiment, the storage device 111 can include various types of non-transitory computer-readable storage mediums. For example, the storage device 111 can be an internal storage system, such as a flash memory, a random access memory (RAM) for temporary storage of information, and/or a read-only memory (ROM) for permanent storage of information. The storage device 111 can also be an external storage system, such as a hard disk, a storage card, or a data storage medium. The at least one processor 112 can be a central processing unit (CPU), a microprocessor, or other data processor chip that performs functions of the calculation system 10 in the computing device 100.

In the embodiment, the storage device 111 stores a map database 1111 and a preset kook up table 1112. The map database 1111 stores road maps of areas and locations of dangerous roads in the area. The area can be a country, a province, or a city. The kook up table 1112 records information of relationships between preset risk coefficients, purchase prices of vehicles, and insurance fees associated with the preset risk coefficients and the purchase prices of vehicles.

The calculation system 10 includes, but is not limited to, a decryption module 11, a determination module 12, and a calculation module 13.

The first communication unit 113 can receive the encrypted data transmitted from the electronic device 200. The decryption module 11 can decrypt the encrypted data according to a preset decryption algorithm, and reveal the core data. The decryption algorithm corresponds to the preset encryption algorithm.

The determination module 12 can determine a driving risk level of the vehicle based on the core data, and seek a comprehensive risk coefficient associated with the driving risk level. In the embodiment, the driving risk level includes a road conditions risk level and a driving style risk level.

In one embodiment, the determination module 12 determines the road conditions risk level based on locations contained in the core data and the dangerous roads stored in the map database 1111. The determination module 12 determines the driving style risk level based on the vehicle accelerations and the driving style contained in the core data.

Moreover, the determination module 12 determines whether the vehicle is driven along dangerous roads by comparing the locations contained in the core data with the dangerous roads stored in the map database 1111. When the vehicle is driven along a dangerous road, the determination module 12 further counts the number of times that the vehicle is driven along dangerous roads, and determines the road conditions risk level according to the cumulative number of times, and obtains a road risk coefficient associated with the determined road conditions risk level. The determination module 12 counts the number of times that a vehicle is accelerated at a rate greater than the preset acceleration rate and instances of driving style creating danger which is contained in the core data. A driving style risk level is determined according to the counted number of occurrences, and a driving style risk coefficient associated with the driving style risk level is thus obtained.

The determination module 12 further determines the risk level on a comprehensive basis according to the driving style risk coefficient, a preset proportion of the driving style risk coefficient, the road conditions risk coefficient, and a preset proportion of the road conditions risk coefficient, and a comprehensive risk coefficient is thus obtained. For example, the portion of the road conditions risk coefficient can be 80% and the portion of the driving style risk coefficient can be 20%.

The calculation module 13 can calculate an insurance fee of the vehicle according to the determined comprehensive risk coefficient and information stored in a look up table.

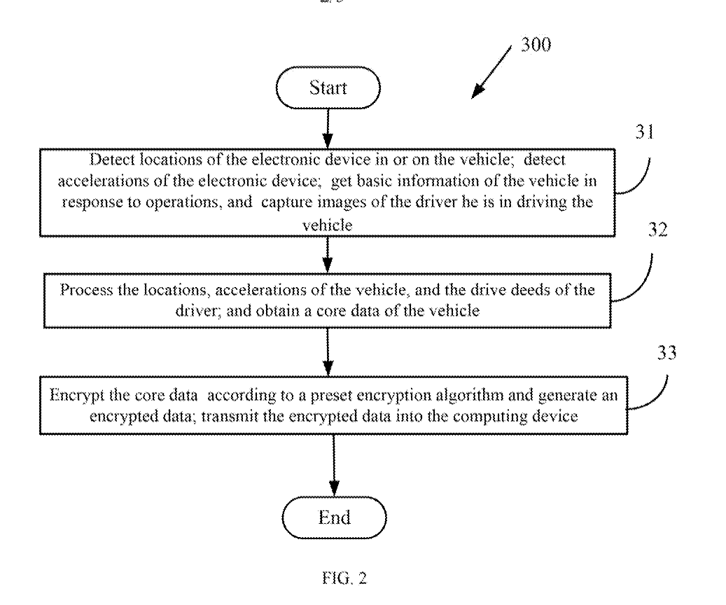

FIG. 2 illustrates a method for obtaining core data of a vehicle insurance fee calculation. The example method 300 is provided by way of example, as there are a variety of ways to carry out the method. The method 300 described below can be carried out using the configurations illustrated in FIG. 1, for example, and various elements of these figures are referenced in explaining example method 300. Each block shown in FIG. 2 represents one or more processes, methods or subroutines, carried out in the exemplary method 300. Additionally, the illustrated order of blocks is by example only and the order of the blocks can change. The exemplary method 300 can begin at block 31. Depending on the embodiment, additional steps can be added, others removed, and the ordering of the steps can be changed.

At block 31, the location detection unit detects location of the electronic device in or on the vehicle. The acceleration detection unit detects accelerations of the electronic device and the input unit obtains basic information of the vehicle in response to user operation. The image capturing unit captures images of the driver as he is driving the vehicle.

At block 32, the processing unit processes the locations, accelerations of the vehicle, and the images of the driver, and obtains a core data of the vehicle.

At block 33, the encryption unit encrypts the core data according to a preset encryption algorithm. The second communication unit transmits the encrypted data into the computing device.

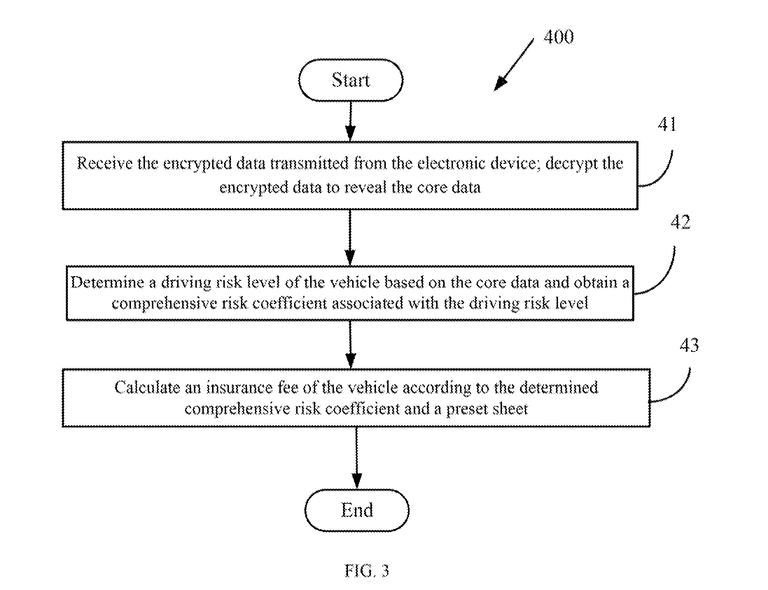

FIG. 3 illustrates a method for calculating vehicle insurance fee. The example method 400 is provided by way of example, as there are a variety of ways to carry out the method. The method 400 described below can be carried out using the configurations illustrated in FIG. 1, for example, and various elements of these figures are referenced in explaining example method 400. Each block shown in FIG. 3 represents one or more processes, methods, or subroutines, carried out in the exemplary method 400. Additionally, the illustrated order of blocks is by example only and the order of the blocks can change. The exemplary method 400 can begin at block 41. Depending on the embodiment, additional steps can be added, others removed, and the ordering of the steps can be changed.

At block 41, the first communication unit receives the encrypted data transmitted from the electronic device. The decryption module decrypts the encrypted data according to a preset decryption algorithm associated with the preset encryption algorithm to reveal the core data.

At block 42, the determination module determines a driving risk level of the vehicle based on the core data and obtains a comprehensive risk coefficient associated with the driving risk level.

At block 43, the calculation module calculates an insurance fee of the vehicle according to the determined comprehensive risk coefficient and information stored in the look up table.

The embodiments shown and described above are only examples. Many details are often found in the art and many such details are therefore neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A method for calculating vehicle insurance fee executable by at least one processor of a computing device, the method comprising:
receiving core data transmitted from an electronic device, wherein the electronic device is associated with a vehicle, the core date comprises driving data of the vehicle, driving style of a driver of the vehicle, and purchase price of the vehicle, the core data is obtained by the electronic device;
determining a driving risk level of the vehicle according to the received core data;
obtaining a comprehensive risk coefficient associated with the driving risk level; and
calculating an insurance fee of the vehicle based on the comprehensive risk coefficient and information stored in a look up table, wherein the information in the look up table comprises relationships between preset risk coefficients, purchase prices of vehicles, and insurance fees associated with the preset risk coefficients and the purchase prices of vehicles.

2. The method according to claim 1, wherein the driving data of the vehicle comprises locations where the vehicle is driven and accelerations which are greater than a preset acceleration, the driving style of the driver are deemed to be dangerous.

3. The method according to claim 2, wherein the driving data of the vehicle comprises images of a driver captured by the electronic device in the process of driving the vehicle.

4. The method according to claim 3, further comprising:
determining the driving style risk level based on the accelerations, captured images of the driver, and the driving style contained in the core data; and
getting a driving style risk coefficient associated with the driving style risk level.

5. The method according to claim 2, wherein the driving risk level comprises a road conditions risk level and a driving style risk level.

6. The method according to claim 5, further comprising:
determining the road conditions risk level based on the locations contained in the core data and dangerous roads stored in a map database.

7. The method according to claim 6, further comprising:
determining whether the vehicle is driven along the dangerous roads by comparing the locations contained in the core data with the dangerous roads stored in the map database;
counting the number of times the vehicle is driven along dangerous roads;
determining the road conditions risk level according to the accounted times, and
obtaining a road risk coefficient associated with the determined road conditions risk level.

8. The method according to claim 5, further comprises:
determining the driving style risk level based on the accelerations and the driving style contained in the core data; and
getting a driving style risk coefficient associated with the driving style risk level.

9. The method according to claim 8, wherein the driving style risk level is determined by:
counting the number of times that a vehicle is accelerated at a rate greater than the preset acceleration rate, and the number of instances of driving style creating danger which is contained in the core data.

10. The method according to claim 5, wherein the comprehensive risk coefficient is determined on a comprehensive basis according to the driving style risk coefficient, a preset proportion of the driving style risk coefficient, the road conditions risk coefficient, and a preset proportion of the road conditions risk coefficient.

11. A non-transitory storage medium having stored thereon instructions that, when executed by a processor of a computing device, causes the processor to perform a method for calculating vehicle insurance fee, wherein the method comprises:
receiving core data transmitted from an electronic device, wherein the electronic device is associated with a vehicle, the core date comprises driving data of the vehicle, driving style of a driver of the vehicle, and purchase price of the vehicle;
determining a driving risk level of the vehicle according to the received core data;
obtaining a comprehensive risk coefficient associated with the driving risk level; and
calculating an insurance fee of the vehicle based on the comprehensive risk coefficient and a preset sheet, wherein the preset sheet records relationships between preset risk coefficients, purchase prices of vehicles, and insurance fees associated with the preset risk coefficients and the purchase prices of vehicles.

12. The non-transitory storage medium according to claim 11, wherein the driving data of the vehicle comprises locations where the vehicle is driven and accelerations which are greater than a preset acceleration, the driving style of the driver are deemed to be dangerous.

13. The non-transitory storage medium according to claim 12, further comprising:
determining a road conditions risk level based on the locations contained in the core data and dangerous roads stored in a map database;
getting a road risk coefficient associated with the determined road conditions risk level;
determining a driving style risk level based on the accelerations and the driving style contained in the core data; and
getting a driving style risk coefficient associated with the driving style risk level.

14. The non-transitory storage medium according to claim 13, wherein the comprehensive risk coefficient is determined on a comprehensive basis according to the driving style risk coefficient, a preset proportion of the driving style risk coefficient, the road conditions risk coefficient and a preset proportion of the road conditions risk coefficient.

15. A computing device, comprising:
a processor; and
a storage device that stores one or more programs which, when executed by the at least one processor, cause the processor to:
receiving core data transmitted from an electronic device, wherein the electronic device is associated with a vehicle, the core date comprises driving data of the vehicle, driving styles of a driver of the vehicle, and purchase price of the vehicle;
determining a driving risk level of the vehicle according to the received core data;
obtaining a comprehensive risk coefficient associated with the driving risk level; and
calculating an insurance fee of the vehicle based on the comprehensive risk coefficient and a preset sheet, wherein the preset sheet records relationships between preset risk coefficients, the prices of vehicles, and insurance fees associated with the preset risk coefficients and the prices of vehicles.

16. The computing device according to claim 15, wherein the driving data of the vehicle comprises locations where the vehicle is driven, and accelerations which are rapider than a preset acceleration, the driving styles of the driver are deemed to be dangerous.

17. The computing device according to claim 16, wherein the driving risk level comprises a road conditions risk level and a driving style risk level, the processor is caused to determine the road condition risk level based on the locations contained in the core data and dangerous roads stored in a map database, and a road risk coefficient associated with the determined road condition risk level; and the driving style risk level based on the accelerations and the driving style contained in the core data, and a driving style risk coefficient associated with the driving style risk level.

18. The computing device according to claim 17, further comprising:
determining whether the vehicle is driven along the dangerous roads by comparing the locations contained in the core data with the dangerous roads stored in the map database;
counting the number of times the vehicle is driven along dangerous roads.

19. The computing device according to claim 18, wherein the driving style risk level is determined by:
counting the number of times that a vehicle is accelerated at a rate greater than the preset acceleration rate, and the number of instances of driving style creating danger which is contained in the core data.

20. The computing device according to claim 19, wherein the comprehensive risk coefficient is determined on a comprehensive basis according to the driving style risk coefficient, a preset proportion of the driving style risk coefficient, the road conditions risk coefficient, and a preset proportion of the road conditions risk coefficient.
